(19) United States
(12) Patent Application Publication
(10) Pub. No.: US 2016/0342024 A1
(43) Pub. Date: Nov. 24, 2016

(54) A transflective liquid crystal panel and a liquid crystal panel display using the same

(71) Applicant: SHENZHEN CHINA STAR OPTOELECTRONICS TECHNOLOY CO., LTD., Shenzhen, Guangdong (CN)

(72) Inventor: Chang XIE, Shenzhen, Guangdong (CN)

(73) Assignee: Shenzhen China Star Optoelectronics Technology Co., Ltd., Shenzhen, Guangdong (CN)

(21) Appl. No.: 14/422,353

(22) PCT Filed: Jan. 5, 2015
(86) PCT No.: PCT/CN2015/070121

§ 371 Date: Feb. 19, 2015

(30) Foreign Application Priority Data
Dec. 10, 2014 (CN) 201410757085.8

(51) Int. Cl. G02F 1/1335; G02F 1/1333; G02F 1/1343

(52) U.S. Cl. CPC G02F 1/133555; G02F 1/133514; G02F 1/134309; G02F 1/133553; G02F 1/133345; G02F 1/133528; G02F 2201/121; G02F 2201/123

(57) ABSTRACT

The present invention discloses a transflective liquid crystal panel comprises both an array substrate and a color film substrate disposed correspondingly to each other and a liquid crystal layer located between the array substrate and the color film substrate, the array substrate comprises a plurality of pixel regions, and each pixel region comprises a transmissive region and a reflective region, wherein, a common electrode layer is disposed on the color film substrate and located at a side closed to the liquid crystal layer on the color film substrate; on the array substrate, a first pixel electrode is disposed in the transmissive region to form an electrode structure of a VA module on a liquid crystal panel of the transmissive region, and a second pixel electrode is disposed in the reflective region to form a electrode structure of an ASV module on a liquid crystal panel of the reflective region. The present invention further discloses a liquid crystal display of the foregoing transflective liquid crystal panel.

### FIELD OF THE INVENTION

The present invention relates to a liquid crystal display technology field, and to a transflective liquid crystal panel and a liquid crystal panel display using the same.

### BACKGROUND OF THE INVENTION

Nowadays, LiquidCrystalDisplay (referred to as LCD) is a mainstreamed product on the market based on its outstanding performances and mature technologies. A liquid crystal panel is a key component of LCD, the liquid crystal panel is substantially formed with a color film substrate and an array substrate which is cell-assembled, a liquid crystal cell is constituted by filling liquid crystal between the color film substrate and the array substrate. The liquid crystal panel according to types of light sources can be classified into transmissive type reflective type and transflective type (semi-transmissive and semi-reflective).

Wherein, a light source is mainly a backlight source in the transmissive liquid crystal panel, the backlight source is disposed at the back of the liquid crystal panel, and pixel electrodes of the array substrate are transparent electrodes as a tranmissive region which is facilitate to transmit light from the backlight source passing a liquid crystal layer to display images; a light source is mainly a front light source or an external light source in the reflective liquid crystal panel, and a metal or other reflective electrodes with good reflective characteristic materials is applied in the array substrate as a reflective region which is suitable to reflect light from the front light source or the external light source; the transflective liquid crystal display panel can be regarded as a combination of the transmissive liquid crystal display panel and the reflective liquid crystal display panel, both the reflective region and the transmissive region are disposed on the array substrate so that display images can be processing by utilizing the backlight source and the front source or external source simultaneously.

An advantage of the transmissive liquid crystal panel is able to display bright images in dark environments, but defects are a small ratio of penetrating light to light emitting from the backlight source and low utilization of the backlight source; increasing brightness of backlight source largely to increase displaying brightness causes high energy consumption. An advantage of the reflective liquid crystal panel is cable of utilizing external light source to result into low energy consumption correspondingly, but a defect is not capable of displaying images in dark environments because relying on external light source. A transflective liquid crystal display panel has both advantages of the transmissive liquid crystal display panel and the reflective liquid crystal display panel so that bright images can be displayed in the dark environments for utilizing indoor and outdoor as well. Therefore, it can be applied broadly in display equipments of portable mobile devices, for example, mobile phones, digital cameras, GPRS and etc.

However, a defect of transflective liquid crystal panel is: light emitted from the transmissive region passes only one time through the liquid crystal layer and light emitted from the reflective region passes twice times through the liquid crystal layer, therefore, light emitted from different sources in transflective liquid crystal display are caused in different optical paths between the reflective region and the transmissive region to result in a larger chromatic aberration between the transmissive region and the reflective region and then further induce color discordant situation in images displayed within the transflective liquid crystal display. In order to improve color discordant situation, a design method of dual cell spacing gap is applied in the transflective liquid crystal panel nowadays to insure phase retardations in liquid crystal of the reflective region and phase retardations in liquid crystal of the transmissive region the same (therefore, have phase retardations of light passing through two regions equivalent and matching to each other), and then to insure smaller chromatic aberration and color coordinate between the transmissive region and the reflective region via having a cell thickness of the reflective region half of a cell thickness of transmissive region. However, because of differences of cell thicknesses existing in the liquid crystal cell in this transflective liquid crystal panel structure to induce manufacturing technology complexity of liquid crystal panels, evenness of cell thicknesses is not easy to control.

### SUMMARY

Because of the problem aforementioned, the technology problems solved in the present invention is focus on defects in the tranflective liquid crystal panel and provide a transflective liquid crystal panel and a liquid crystal display which is comprising the liquid crystal panel, the liquid crystal panel simplifies manufacturing technologies in liquid crystal panels under a situation of equivalent cell thicknesses between the transmissive region and the reflective region; the chromatic aberration is smaller and the color is coordinated between the transmissive region and the reflective region to improve displaying qualities of liquid crystal displays.

In order to achieve the object above, a technology program is applied in the present invention as below:

A transflective liquid crystal panel comprises both an array substrate and a color film substrate disposed correspondingly to each other and a liquid crystal layer located between the array substrate and the color film substrate, the array substrate comprises a plurality of pixel regions, and each pixel region comprises a transmissive region and a reflective region, wherein, a common electrode layer is disposed on the color film substrate and located at a side closed to the liquid crystal layer on the color film substrate; a first pixel electrode is disposed in the transmissive region to form an electrode structure of a VA module on a liquid crystal panel of the transmissive region, and a second pixel electrode is disposed in the reflective region to form a electrode structure of an ASV module on a liquid crystal panel of the reflective region.

Wherein, a reflective layer is further disposed on the array substrate, a covered region with the reflective layer is reflective region, an uncovered region without the reflective layer is trasmissive layer.

Wherein, an insulation layer is disposed on the array substrate, the reflective layer is covered by the insulation layer and the first pixel electrode and the second pixel electrode are located on the insulation layer.

Wherein, a different optical path of the transmissive region is twice as much as a different optical path of the reflective region.

Wherein, the liquid crystal panel further comprises a first polarizer and a second polarizer, the first polarizer is disposed at a side of the color film substrate away from the liquid crystal layer, and the second polarizer is disposed at a side of the array substrate away from the liquid crystal layer.

Wherein, a liquid crystal of the liquid crystal layer is negative liquid crystal.

Wherein, a thickness of a corresponding portion of the transmissive region and a thickness of a corresponding portion of the reflective region are the same in the liquid crystal panel.

Another aspect of the present invention is to provide a liquid crystal display comprising a liquid crystal panel and a backlight module, the liquid crystal panel is disposed corresponding to the backlight module, and the backlight module provides displaying light source to the liquid crystal panel, wherein, a transflective liquid crystal panel is applied in the liquid crystal panel described as above.

A transmissive region and a reflective region are disposed at a pixel region in the transflective liquid crystal panel provided from embodiments of the present invention, wherein, an electrode structure of VA module is applied at the transmissive region and an electrode structure of ASV module is applied at the reflective module to achieve semi-transmissive and semi-reflective effects when displaying. A vertical electric field under the VA module in the tranmissive region is even more even to insure parallel arrangements for every electric field and then decrease driving voltage of the liquid crystal display and increase light efficiency; the electrode structure of the ASV module applied in the reflective region expands a viewing angle and increase a contrast ratio. Because thicknesses of the transflective liquid crystal panel is the same as a thickness of a corresponding portion of the reflective region and a thickness of a corresponding portion of the tranmissive region, and as long as thicknesses of the liquid crystal layer remains identical, manufacturing technologies of the liquid crystal panel can be simplified enormously and display qualities of the transflective liquid crystal display can be improved simultaneously.

### BRIEF DESCRIPTION OF THE DRAWING

FIG. 1 is a structural schematic diagram showing a transflective liquid crystal panel without applying voltage provided from an embodiment of the present invention.

FIG. 2 is a structural schematic diagram showing a transflective liquid crystal panel with applying voltage provided from an embodiment of the present invention.

FIG. 3 is a structural schematic diagram provided form the embodiment of the prevent invention.

### DETAILED DESCRIPTION OF THE EMBODIMENTS

For those skilled in the art even better understand the technology programs of the present invention, the transflective liquid crystal panel and liquid crystal display in the present invention are further described in detail in conjunction with drawing and embodiments.

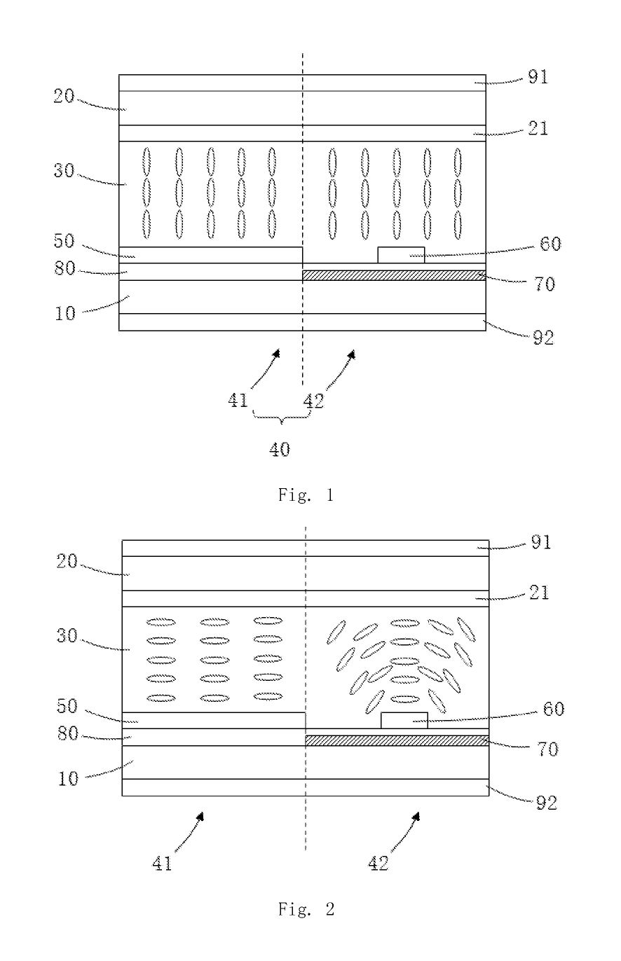

Please refer to FIG. 1 and FIG. 2, wherein, FIG. 1 is a structural schematic diagram showing a transflective liquid crystal panel without applying voltage provided from an embodiment of the present invention, and FIG. 2 is a structural schematic diagram showing a transflective liquid crystal panel with applying voltage provided from an embodiment of the present invention. The transflective liquid crystal panel comprises both an array substrate 10 and a color film substrate 20 disposed correspondingly to each other and a liquid crystal layer 30 located between the array substrate 10 and the color film substrate 20, the array substrate 10 comprises a plurality of pixel regions 40, and each pixel region 40 comprises a transmissive region 41 and a reflective region 42. Wherein, a common electrode layer 21 is disposed on the color film substrate 20 and located at a side closed to the liquid crystal layer 30 on the color film substrate20, on the array substrate 10, a first pixel electrode 50 is disposed in the transmissive region 41 to form an electrode structure of a VA (Vertical Alignment) module on a liquid crystal panel of the transmissive region 41, and a second pixel electrode 60 is disposed in the reflective region 42 to form a electrode structure of an ASV (Action Script Viewer) module on a liquid crystal panel of the reflective region 42.

In particular, as shown in FIG. 1 and FIG. 2, a reflective layer 70 is further disposed on the array substrate 10, a covered region with the reflective layer 70 is the reflective region 42, an uncovered region without the reflective layer 70 is the trasmissive layer 42. Further, an insulation layer 80 is disposed on the array substrate 10, the reflective layer 70 is covered by the insulation layer 80 and the first pixel electrode 50 and the second pixel electrode 60 are located on the insulation layer 80. Further, the liquid crystal panel further comprises a first polarizer 91 and a second polarizer 92, the first polarizer 91 is disposed at a side of the color film substrate 20 away from the liquid crystal layer 30, and the second polarizer 92 is disposed at a side of the array substrate 10 away from the liquid crystal layer 30.

In this embodiment, positive liquid crystal is applied in liquid crystal of the liquid crystal layer 30, and an initial orientation of liquid crystal molecule in the liquid crystal layer 30 is vertical with planes of the polarizer 91 and 92.

When applying voltage to pixel electrodes 50 and 60, because being affected by vertical electric field, negative liquid crystal molecules are gradually becoming vertically arranged and phase retardations are appeared at horizontal orientation. Because the electrode structure of the ASV module is applied at the reflective region 42, negative liquid crystal molecules at the reflective region 42 are affected by an electric field of the ASV module and then turned into the situation of the Action Script Viewer to produce less phase retardations at the horizontal orientation. Based on the overall consideration, a larger horizontal phase retardation Δn₁ is occurred under action of the vertical electric field in negative liquid crystal of the transmissive region 41, yet a smaller horizontal phase retardation Δn₂ is occurred under action of the oblique electric field in negative liquid crystal of the reflective region 42. Therefore, light passing through the transmissive region 41 causes even more phase retardations, which is about Δn₁=2Δn₂, than light passing through the reflective region 42 via a width optimization of the second pixel electrode 60 at the reflective region 42. Because a reflective factor of light in the reflective region 42 is twice-equivalent passing through the liquid crystal layer 30, matching phase retardations of the transmissive region and the reflective region can be achieve and then semi-transmissive and semi-reflective displaying affectivities can be accomplished.

In actual preparation processes, an optimized width can be explored by applying methods of experimental testing in the width optimization of the second pixel electrode 60. The width assurance is related to liquid crystal properties (ex: birefringence properties, properties of dielectric anisotropy, dielectric constants and etc.). According to a testing method for comprising certain widths of a liquid crystal pixel panel electrode 60 as following:

Firstly, different testing panels can be manufactured according to several pre-decided electrode widths, and a certain liquid crystal is filled in these testing panels. Secondly, making a V-T (voltage-transmissivity) curve characteristics on the transmissive region and the reflective region of the several testing panels; if the curve characteristics of the transmissive region and the reflective region of the testing panels are identical in an error range, thus a phase retardation of the transmissive region is about twice of a phase retardation of the reflective region and then a pixel electrode width in the reflective region of the testing panel can be a reference in actual production. The aforementioned pixel electrode width is not restricted in the embodiment of the present invention, yet substantially based on the identical phase retardation occurred from the liquid crystal layer passed by light from the transmissive region and the reflective region at the same pixel region in the actual production.

In the present embodiment, a thickness of a corresponding portion of the reflective region 42 and a thickness of a corresponding portion of the transmissive region 41 are the same in the liquid crystal layer 30, thus the liquid crystal panel is a transflective liquid crystal panel with a single cell thickness. Because an even cell thickness of a liquid crystal cell in the liquid crystal panel, a manufacturing process can be simplified largely in a situation of identical thickness of the liquid crystal layer, and then the displaying qualities of the tranflective liquid crystal display can be improved at the same time.

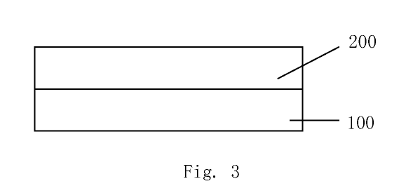

The present embodiment further provides a liquid crystal display as shown in FIG. 3: the liquid crystal display comprises a liquid crystal panel 200 and a backlight module 100 disposed to each other correspondingly, and the backlight module 100 provides displaying light source to the liquid crystal panel 200, wherein, the liquid crystal panel 200 is the aforementioned transflective liquid crystal panel.

It should be noted that terminologies such as “a first”, “a second”, “the first” and “the second” herein are just used in distinguishing one entity or operation from another entity or operation, and are not bound to require or imply any kind of the actual relationship or sequence existing between these entities and operation. Moreover, terminologies “include”, “comprise” or any other variations are intended to cover all nonexclusive containing, such that a process, method, article, or equipment including a series of elements includes not only the listed elements, but also other element not listed specifically, or includes the inherent elements thereof. Without more restriction, the element defined by the sentence “including/comprising a . . . ” does not exclude that the process, method article, or equipment includes more than one or that element.

Although the foregoing embodiments have been described in some detail for purposes of clarity of understanding, the present invention is not limited to the detailed provided. These are many alternative ways of implementing the present invention. The disclosed embodiments are illustrative and not restrictive.

1. A transflective liquid crystal panel comprises both an array substrate and a color film substrate disposed correspondingly to each other and a liquid crystal layer located between the array substrate and the color film substrate, the array substrate comprises a plurality of pixel regions, and each pixel region comprises a transmissive region and a reflective region, wherein, a common electrode layer is disposed on the color film substrate and located at a side closed to the liquid crystal layer on the color film substrate; on the array substrate, a first pixel electrode is disposed in the transmissive region to form an electrode structure of a VA module on a liquid crystal panel of the transmissive region, and a second pixel electrode is disposed in the reflective region to form a electrode structure of an ASV module on a liquid crystal panel of the reflective region.

2. The transflective liquid crystal panel according to claim 1, wherein, a reflective layer is further disposed on the array substrate, a covered region with the reflective layer is the reflective region, an uncovered region without the reflective layer is the trasmissive layer.

3. The transflective liquid crystal panel according to claim 2, wherein, an insulation layer is disposed on the array substrate, the reflective layer is covered by the insulation layer and the first pixel electrode and the second pixel electrode are located on the insulation layer.

4. The transflective liquid crystal panel according to claim 3, wherein, a different optical path of the transmissive region is twice as much as a different optical path of the reflective region.

5. The transflective liquid crystal panel according to claim 1, wherein, the liquid crystal panel further comprises a first polarizer and a second polarizer, the first polarizer is disposed at a side of the color film substrate away from the liquid crystal layer, and the second polarizer is disposed at a side of the array substrate away from the liquid crystal layer.

6. The transflective liquid crystal panel according to claim 2, wherein, the liquid crystal panel further comprises a first polarizer and a second polarizer, the first polarizer is disposed at a side of the color film substrate away from the liquid crystal layer, and the second polarizer is disposed at a side of the array substrate away from the liquid crystal layer.

7. The transflective liquid crystal panel according to claim 5, wherein, a liquid crystal of the liquid crystal layer is negative liquid crystal.

8. The transflective liquid crystal panel according to claim 2, wherein, a thickness of a corresponding portion of the transmissive region and a thickness of a corresponding portion of the reflective region are the same in the liquid crystal panel.

9. The transflective liquid crystal panel according to claim 3, wherein, a thickness of a corresponding portion of the transmissive region and a thickness of a corresponding portion of the reflective region are the same in the liquid crystal panel.

10. The transflective liquid crystal panel according to claim 5, wherein, a thickness of a corresponding portion of the transmissive region and a thickness of a corresponding portion of the reflective region are the same in the liquid crystal panel.

11. A liquid crystal display comprises a liquid crystal panel and a backlight module, the liquid crystal panel is disposed corresponding to the backlight module, and the backlight module provides displaying light source to the liquid crystal panel, wherein, the liquid crystal panel is a transflective liquid crystal panel, the transflective liquid crystal panel comprises both an array substrate and a color film substrate disposed correspondingly to each other and a liquid crystal layer located between the array substrate and the color film substrate, the array substrate comprises a plurality of pixel regions, and each pixel region comprises a transmissive region and a reflective region, wherein, a common electrode layer is disposed on the color film substrate and located at a side closed to the liquid crystal layer on the color film substrate; a first pixel electrode is disposed in the transmissive region to form an electrode structure of a VA module on a liquid crystal panel of the transmissive region, and a second pixel electrode is disposed in the reflective region to form a electrode structure of an ASV module on a liquid crystal panel of the reflective region.

12. The liquid crystal display according to claim 11, wherein, a reflective layer is further disposed on the array substrate, a covered region with the reflective layer is reflective region, an uncovered region without the reflective layer is trasmissive layer.

13. The liquid crystal display according to claim 12, wherein, an insulation layer is disposed on the array substrate, the reflective layer is covered on the insulation layer and the first pixel electrode and the second pixel electrode are located on the insulation layer.

14. The liquid crystal display according to claim 13, wherein, a different optical path of the transmissive region is twice as much as a different optical path of the reflective region.

15. The liquid crystal display according to claim 11, wherein, the liquid crystal panel further comprises a first polarizer and a second polarizer, the first polarizer is disposed at a side of the color film substrate away from the liquid crystal layer, and the second polarizer is disposed at a side of the array substrate away from the liquid crystal layer.

16. The liquid crystal display according to claim 12, wherein, the liquid crystal panel further comprises a first polarizer and a second polarizer, the first polarizer is disposed at a side of the color film substrate away from the liquid crystal layer, and the second polarizer is disposed at a side of the array substrate away from the liquid crystal layer.

17. The liquid crystal display according to claim 15, wherein, a liquid crystal of the liquid crystal layer is negative liquid crystal.

18. The liquid crystal display according to claim 12, wherein, a thickness of a corresponding portion of the transmissive region and a thickness of a corresponding portion of the reflective region are the same in the liquid crystal panel.

19. The liquid crystal display according to claim 13, wherein, a thickness of a corresponding portion of the transmissive region and a thickness of a corresponding portion of the reflective region are the same in the liquid crystal panel.

20. The liquid crystal display according to claim 15, wherein, a thickness of a corresponding portion of the transmissive region and a thickness of a corresponding portion of the reflective region are the same in the liquid crystal panel.
